(19) United States
(12) Patent Application Publication
(10) Pub. No.: US 2009/0092236 A1
(43) Pub. Date: Apr. 9, 2009

(54) SYSTEM AND METHOD FOR INTEGRATED INTERCOM AND DISTRIBUTED AUDIO/VIDEO SYSTEM WITH SECURITY INTERFACE

(76) Inventor: Jeffrey Vaughn Wilson, Wilsonville, OR (US)

Correspondence Address: General Electric Company;GE Global Patent Operation, PO Box 861, 2 Corporate Drive, Suite 648, Shelton, CT, 06484, US

(21) Appl. No.: 11/868,581

(22) Filed: Oct. 8, 2007

(51) Int. Cl. H04M 11/00; H04M 9/00

(52) U.S. Cl. 379/93.17; 379/172; 379/93.36

(57) ABSTRACT

A system and method for an integrated intercom and distributed audio/video system with a security interface is provided. An intercom station is configured to couple with a powerline and to transmit and/or receive system control signals over the powerline. The intercom station may be further configured to transmit and/or receive live audio data and/or live image data over the powerline in real time or in near real time. The system may include two intercom stations configured to be coupled with a powerline. At least one of the two intercom stations may be configured to be mounted to a wall. At least one of the two intercom stations may include an intercom adapter configured to transmit and receive a uniquely addressed, modulated carrier wave over the powerline.

### BACKGROUND

1. Field of the Invention

The field of the invention relates to distributed audio/video systems and intercom systems generally, and more particularly, to a digital intercom solution that provides multi-source, multi-zone distributed audio/video and two-way intercom capabilities for existing home and business applications based on communication over existing powerlines.

2. Discussion of Related Art

Distributed audio/video systems having a structured-wiring architecture or a powerline architecture are known and route audio signals from a central location to one or more remote speakers located in different or shared zones. Intercom systems having a structured-wiring architecture are also known. Most of the known intercom systems typically route audio and/or video signals from one or more remote room or door stations to a central station, and route audio and/or video signals from the central station to one or more of the remote room or door stations. But several known intercom systems permit peer-to-peer communication among all intercom stations. High wiring costs, however, make conventional distributed audio/video systems and intercom systems expensive to install in new construction and very expensive to retrofit to existing construction. Having disparate power source requirements and different operating requirements, many structured-wiring digital audio systems and intercom systems are installed separately, which only increases the total installation cost.

Newer generation intercom systems, also having a structured-wiring architecture, have been made by General Electric of Schenectady, N.Y., by Russound of Newmarket, N.H., by OnQ of Middletown, Pa., and by other companies. These intercom systems integrate with new or existing distributed audio/video systems by routing CAT5 ethernet cable from a central hub to one or more keypads, door stations, and/or door strike modules; and by routing standard gauge speaker wires from new or existing (intercom and/or audio) speakers to the central hub. The central hub itself is coupled to a power source and can be installed in a closet or in a rack of audio/visual components. Such structured-wiring systems, however, are still very expensive to install in retrofit construction due to high wiring costs.

Various types of intercom systems have been developed for the retrofit market. One type transmits audio and system control signals between room and door stations and a central station (and/or a telephone) over existing telephone lines. Another type used battery-operated room and door stations to communicate, via a secure wireless network, with a central base station. Both kinds of retrofit systems have limited applicability. The first because few network devices (computers, flat panel displays, audio sources, video sources, etc.) are configured to communicate over telephone lines, and because the number of telephone jacks is typically less than the number of electrical outlets. The second because batteries have to be systematically replaced/recharged, which is time-consuming and expensive.

FIG. 1 is a schematic showing the structured wiring architecture of a conventional integrated intercom and distributed audio/video system 100 (hereinafter, “system 100”). The system 100 includes an intercom subsystem 170 and a distributed audio subsystem 180.

At the core of each subsystem is a hub. The intercom hub 101 links to one or more room stations 102 and to one or more door stations 103 using CAT5 ethernet cable 104. The intercom hub 101 may include multiple room station ports 106 and multiple door station ports 103, as well as an audio port 108, and power port 109 for connecting, via a power wire 110 to a 12V DC power source 105. To permit audio signals to flow to one or more room stations 102 and/or door stations 103, a CAT5 ethernet cable may link the audio port 108 with an intercom port 160 formed in the audio hub 150. The audio hub 150 links to one or more remote audio sources 156 and 157. The audio sources 156 and 157 each connect to an audio source input adapter 154 via wires 111. In turn, each audio source input adapter 154 connects to the audio hub 150 via CAT 5 ethernet cable 104. The audio hub 150 includes multiple audio input ports 158, a control port 159 (for optionally linking the audio hub to a security system hub (not shown)), and a power port 160 for connecting, via power wire 110, to a (14V DC) power source 155. The rear of the audio hub 150 may include multiple speaker connectors 151. One or more room speakers 152 connect to each of the speaker connectors 151 using speaker wire 153.

Because conventional distributed audio/video systems and intercom systems, as well as conventional integrated systems are not suitable for retrofits, powerline communication transmission (“PLC”) technology was developed to eliminate the need to install structured wiring. PLC technology permits ordinary electrical wiring to be used as a transmission medium for control, audio, and video signals. For home and business networking applications, PLC technology is easier to set up, faster (up to 200 Mbs), more secure, and more reliable than wireless technology. It also avoids the need to install new wires. PLC technology uses a transmitter, which is plugged into an electrical outlet, to modulate a carrier wave. The encoded carrier signals are uniquely addressed to and decoded by each receiver (electronic or digital device) that is plugged into other electrical outlets throughout the home or business.

Narrowband PLC (used for home automation) is governed by international and open industry standards such as X10 and INSTEON. Broadband PLC (used for home networking) is governed by competing standards developed by the HomePlug Powerline Alliance, the Universal Powerline Association, IEEE, and other entities.

Conventional broadband PLC architecture has been used to link a flat panel display via a powerline with a video source. It has also been used to link still or video cameras via a powerline with a computer on which surveillance software has been installed. It has also been used to link powered speakers via a powerline with streaming audio from the Internet or a personal computer.

What long has been needed is a broadband PLC system that uniquely integrates intercom, distributed audio/video, and security functions to provide live two-way audio/video communication over a powerline, to provide components (such as a television, intercom station, etc.) that are configured to manage operations of the integrated system, and to provide an intercom station configured to monitor audio/video data collected by another intercom station and/or by another component of the integrated system.

### BRIEF DESCRIPTION

An improved intercom station, integrated intercom and distributed audio/video system with security interface, and methods for operating the integrated intercom and distributed audio/video system are described and claimed herein. The claimed invention, which is configured to communicate over an existing powerline, eliminates many of the shortcomings associated with prior intercom and distributed audio/video systems having a structured-wire architecture. It also uniquely solves the long felt need identified above by providing an affordable and easily-installed retrofit solution for customers in both residential and commercial markets who desire, need or require a powerline-based local-area network that virtually eliminates wiring costs and affords security features and peer-to-peer, two-way, voice communication alongside traditional distributed audio/video/video features.

As mentioned above, an objective problem left unsolved by prior approaches is how to provide two-way voice communication over a network having a powerline-architecture. One non-limiting solution (or technical effect) provided by embodiments of the claimed invention is an intercom station having a microphone and/or an intercom camera. The microphone may be configured to transmit over a powerline, as part of the modulated carrier wave, a sound detected by the intercom microphone. The intercom camera may be configured to transmit over the powerline, as part of the modulated carrier wave, a still and/or video image captured by the intercom camera. Another solution is an integrated intercom and distributed audio/video system as claimed that includes such an intercom station. Yet another solution is a method for transmitting over the powerline, as part of the modulated carrier wave, the sound detected by the intercom microphone and/or the image captured by the intercom camera.

Other features and advantages will become apparent by reference to the following description taken in connection with the accompanying drawings.

### BRIEF DESCRIPTION OF THE DRAWINGS

For a more complete understanding of aspects of the claimed intercom station, integrated intercom and distributed audio/video system with security interface, and methods for operating the integrated intercom and distributed audio/video system, and the advantages thereof, reference is now made to the following descriptions taken in conjunction with the accompanying drawings, in which:

FIG. 1 is a schematic showing the structured wiring architecture of a conventional integrated intercom and distributed audio/video system;

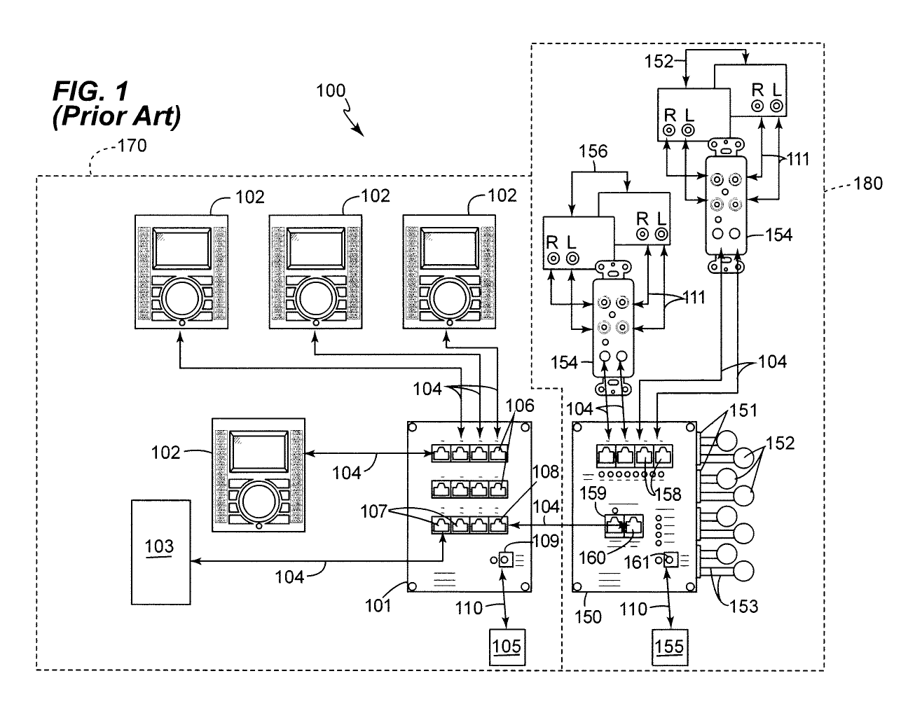

FIG. 2 is a schematic showing a powerline-architecture of an embodiment of the claimed integrated intercom and distributed audio/video system with security interface; and

FIG. 3 is a diagram showing internal components of an embodiment of the claimed intercom station configured to couple with a powerline.

### DETAILED DESCRIPTION

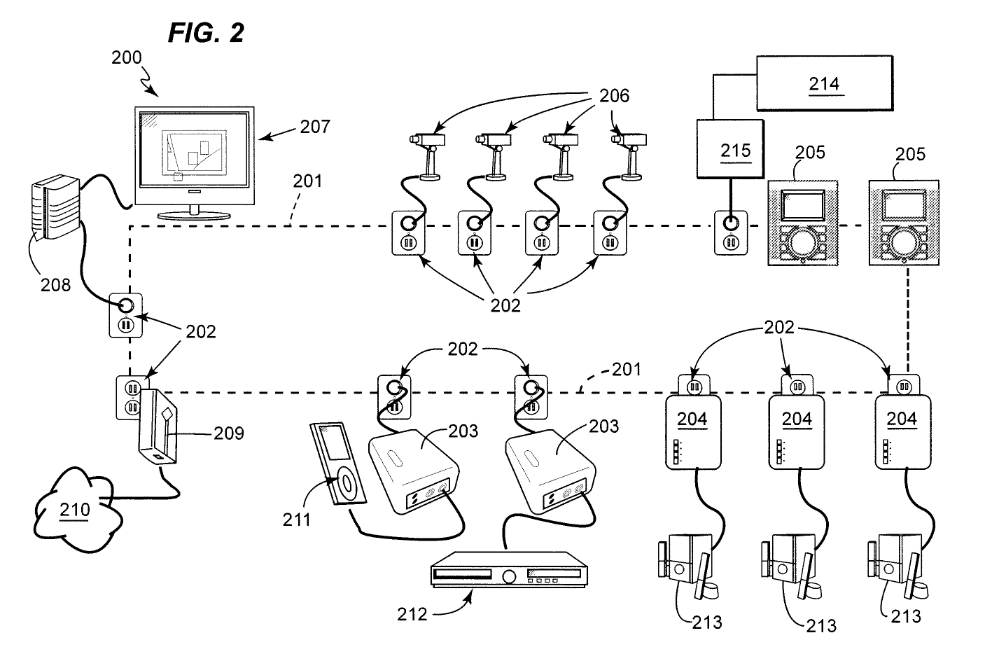

FIG. 2 is a diagram illustrating an example of a claimed integrated intercom and distributed audio/video system 200 (hereinafter, “system 200”) with security interface. The system 200, has a peer-to-peer powerline architecture, and may include one or more of the following components: a powerline-pluggable intercom station 205, a camera 206, a display device 207, a video out adapter 208, an ethernet bridge 209, an audio input device 211, 212, an audio output device (powered speaker) 213, an audio input adapter 203, and an audio output adapter 204, each of which is configured to couple with the powerline 201. One or more of these components may preferably be configured to comply with powerline architecture standards such as those promulgated by the HomePlug Alliance, the Universal Powerline Association, IEEE, or other entities. As used herein, the term, “powerline,” denotes wiring that couples a power source with a device that transfers, stores or consumes electrical power. In an embodiment, the device may be an electrical outlet. In other embodiments, the device may be a power transformer, a capacitor, a resistor, a transistor, etc. In an embodiment, the power source may deliver 120 VAC power. Alternatively, a power source that delivers DC power or another type of AC power may also be used.

In an embodiment, the system 200 may link with a security system 214 via a security system adapter 215. The security system 214 may be any known type of residential or commercial building security system having electrical and/or digital components, such as an alarm, a motion sensor, a camera, a door sensor, a window sensor, a door strike, and the like. The security system 214 may further include a master panel containing a printed circuit board, which comprises a plurality of electrical circuits configured to receive data from, and route command signals to, the security system's electrical and/or digital components. The printed circuit board may include, and/or may be coupled with a computer having a central bus that links a computer processor with one or more of: a computer readable memory, a data port, a wireless transceiver, a display device, an input device, and the like. One or more types of wiring, such as data wiring and/or power wiring, may link each of the security system's electrical and/or digital components with the master panel.

A residential embodiment of the integrated security system 214 may comprise one or more security panels, which may be, or may be equivalent to, a self-contained wireless security panel sold under the trademark SIMON XT, a hybrid security panel sold under the trademark CONCORD 4.0, and a modular security panel sold under the trademark NETWORX.

Embodiments of the integrated security system 214 may comprise commercial security products like a UNIX-based security management system sold under the trademark PICTURE PERFECT; and like security software sold under the trademark FACILITY COMMANDER. Embodiments of the security software may integrate security applications including access control, photo ID and credentialing, digital video surveillance, alarm monitoring, intrusion detection, and visitor management into one seamless security platform. The trademarks SIMON XT, CONCORD 4.0, NETWORX, PICTURE PERFECT, and FACILITY COMMANDER WNX are owned by GE Security, Inc., a Delaware Corporation, with offices in Bradenton, Florida.

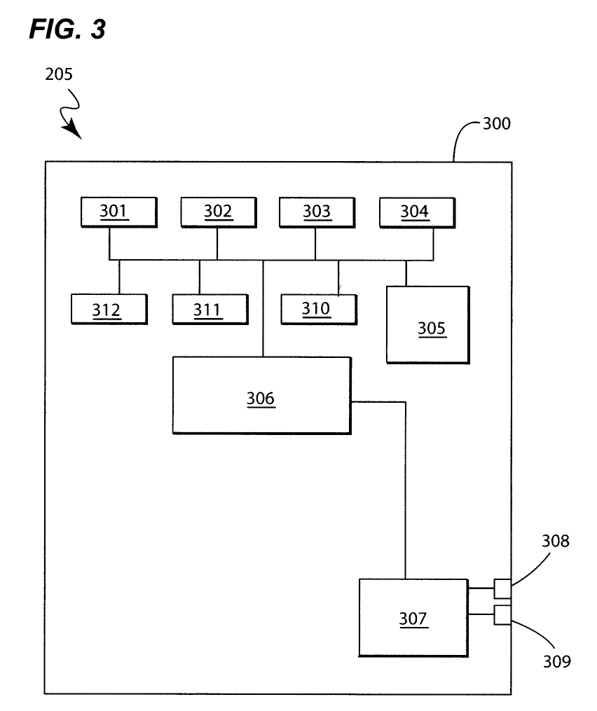

Like the intercom adapter 307 in FIG. 3 described below, the security system adapter 215 may be configured to transmit and receive a uniquely addressed, modulated carrier wave over the powerline 201. The uniquely addressed, modulated carrier wave may include audio data, image data, and system control data sent from the security system 214 to an intercom station 205, or may include audio data, image data, and system control data sent from the intercom station 205 to the security system 214. Each type of data is defined and further described below with respect to the intercom adapter 307.

In embodiments configured for the commercial, government, or residential markets, the security system adapter 215 may be configured to couple the security system with the powerline 201. Coupling the security system adapter 215 with the powerline 201 of the system 200 permits an appropriately configured powerline-pluggable intercom station 205 to be used to arm or disarm the security system 214, and/or to view the status, and/or camera images, of the security system to determine whether and where an alarm event has occurred. Examples of an “alarm event” may include, but are not limited to, an intrusion, fire, smoke, etc.

Coupling the security system adapter 215 with the powerline 201 of the system 200 also expands the security system's two-way voice/video communication from a single built-in location, typically near the security system's master panel, to a central station monitoring system. This allows personnel staffing the central station monitoring personnel to speak directly to the homeowner in the event of an alarm, or to see specific video images of a home that is in alarm to confirm that there is really an emergency. In this configuration, the central station monitoring system may be linked to every intercom station in the home for voice communication, and may be configured to access to any video cameras previously configured to be available for remote viewing in an emergency. In an embodiment, each of the multiple new locations includes an appropriately configured powerline-pluggable intercom station 205, which is linked with the security system 214 via the security system adapter 215.

Referring again to FIG. 2, the ethernet bridge 209 may be an electronic or digital device having sub-components (including software) that are configured to link a network 210 (such as the Internet) to the powerline 201. The display device 207 may be a flat panel liquid crystal display, a flat panel plasma display, or cathode ray tube display, or other means for displaying still and/or video images. The display device 207 may be configured to display an image captured by a camera 206 and/or by an intercom camera (310 in FIG. 3). In an embodiment, the camera 206 and/or the intercom camera 310 may be an IP network camera. As used herein, the term, “IP network camera” denotes a video camera having a built in web server that can be controlled, monitored and viewed from virtually any location via high-speed Internet access.

Each of the audio input devices 211,212 may be a microphone, a digital music player, a CD player, a DVD player, or other means for generating audio data signals. The intercom station 205, display device 207, the video out adapter(s) 208, the ethernet bridge 209, the audio input adapter(s) 203, the audio output adapter(s) 204, and/or the audio output device(s) 213 may removably plug into sockets of the electrical outlets 202. Alternatively, the intercom station 205 may be hardwired to the powerline 201.

Optionally, the video out adapter(s) 208 may be configured to support and/or to interface with one or more cameras 206 and/or one or more intercom cameras (310 in FIG. 3). Such a configuration permits images from the one or more cameras 206 and/or from the one or more intercom cameras (310 in FIG. 3) to be displayed on the display device 207.

The terms “camera” and “intercom camera” refer to digital devices configured to capture an image. Unless otherwise noted, the term “image” includes at least one of a still image and a video image. A camera 206 may be directly plugged into an electrical socket 202 and thereby coupled with a powerline 201. An intercom camera (310 in FIG. 3) may be integral to an intercom station 205 but not configured to directly plug into an electrical socket 202.

Each of the audio input adapter 203 and a video input adapter (not shown) may be an electronic or digital device that accepts line level outputs (transmitted over a powerline) via standard connections (such as, but not limited to, RCA jacks) and plugs into a standard electrical outlet 202.

Each of the audio output adapter 204 and the video output adapter 208 may be an electronic or digital device that can plug into a standard electrical outlet 202 to provide line level output signals received from the powerline 201 to powered speakers, amplifiers, display devices, or other audio-visual products that accept line level inputs. A composite, component, high definition multimedia interface (“HDMI”), or S-video connector may connect a video output adapter 208 to a display device 207. Standard speaker wire may connect an audio output adapter 204 to a powered speaker and/or amplifier. An amplified audio output adapter may be an audio output adapter 204 that is configured to connect to standard stereo speakers and to plug into a standard electrical outlet 202.

Although not shown in FIG. 2, the system 200 may also include a personal computer, a gaming console, a video playback device, a video recording device, a video input device, and/or a handheld computing device coupled, via an intercom or powerline adapter, to the powerline 201. The video recording device may be a digital video recorder (“DVR”) or other type of computer readable memory device. The handheld computing device may be a personal digital assistant (“PDA”), a wireless telephone, and the like.

Additionally, one or more components of system 200 (and/or of the network 210) may include a computer-readable memory device (not shown) that is configured to couple with the powerline, but which is not included in the intercom station(s) 205. The memory device may be configured to store one or more audio files and/or one or more image files (still and/or video). The audio files and/or image files stored in the memory device may be pre-recorded or live-recorded. For example, a commercially-available song, digital photograph, or video may be stored in the memory device. Optionally, a sound, a digital photograph, and/or a video that is live-recorded (in real time or in near-real time) by one or more components of the system 200 may be stored in the memory device. The memory device may be configured to connect with a memory port (such as, but not limited to a USB port) included as part of any of the components of the system 200. Examples of a memory device include, but are not limited to a removable USB disk drive, a CD-ROM disk, a DVD disk, a computer hard drive, and a RAM memory chip. The memory device described above is distinct from the intercom memory 305 shown in FIG. 3 and further described below.

FIG. 3 is a schematic illustrating exemplary components of a powerline-pluggable intercom station 205 (hereinafter, “intercom station 205”). In one aspect, an intercom station may be an electronic or digital device that provides system capability control via a user interface 301, which may include a button, a dial, a keypad, an infrared sensor and associated infrared handheld control device, an intercom display device 302, and so forth. The intercom display device 302 may be configured as a touch-screen. As further noted below, an intercom station 205 may also provide microphone capability, camera capability, and speaker capability for the intercom and security functions of the system 200.

The intercom station 205 may include a computer processor 306 linked via a bus to other components of the intercom station 205. Illustratively, these other components of the intercom station 205 may include, but are not limited to, a user interface device 301 (such as a keypad or touch screen), a display device 302 (such as a LCD panel), an intercom speaker 304, and an intercom sensor 303 (such as a radio/Bluetooth/infrared sensor configured to receive wireless or infrared system control signals from a handheld control device (which may be a personal digital assistant, an appropriately configured mobile telephone, a handheld computer, and the like). The user interface device 301 may be configured to provide one or more system control signals.

The intercom display device 302 (and/or the display device 207) may be configured to display at least one of command prompts, distributed audio/video zones, an entertainment list, and an internet webpage. The internet webpage may include a web configuration page for diagnostics of the system 200, for configuration of a component of the system 200, and for status of a component of the system 200. Additionally, one or more configurations of the system 200 may be stored in one or more memory devices associated with the system 200 to provide a history of configuration changes to restore functionality of the system 200 in the event of an emergency or an alarm. Additionally, one or more components of the network 200 may have their firmware and/or software updated over the powerline 201 and/or the network 210 based on a single system command. These updates require no additional wires or special software.

The intercom display device 302 may also be configured to display one of streaming video from the network 310 (or from a personal computer or computer server coupled to the powerline 201) and still images or video images from an image source coupled with the powerline 201. Non-limiting examples of an image source that may be coupled with the powerline 201 include a CD player, a DVD player, a camera 206, and a computer-readable memory device that is configured to couple with the powerline 201.

The intercom speaker 304 (and/or the audio output device(s) 213) may be configured to play streaming audio from the network 310 (or from a personal computer or computer server coupled to the powerline 201), as well as audio files from an audio source coupled with the powerline 201. Non-limiting examples of an audio source coupled with the powerline 201 include: a CD player, a digital music player, a DVD player, and a computer readable memory device that configured to couple with the powerline 201.

Components of the intercom station 205 may further include an intercom memory 305, a memory port 311 configured to connect to an external memory device, an intercom camera 310, a computer processor 306, an intercom adapter 307, audio/video input 308 and audio/video output 309. The intercom adapter 307 may be integrally, removably, or externally coupled with a housing 300 of the intercom station 205.

In one aspect, an “intercom adapter” may be an electronic or digital device, included as part of an intercom station 205, that transmits and receives audio data, image data, and system control data over a powerline 201, and that connects to the powerline 201 either by plugging into a standard electrical outlet or by being hardwired into a standard 2-gang enclosure. Optionally, a version of an “intercom adapter” may provide an auxiliary audio input via RCA connections and/or a standard audio mini-jack.

The intercom adapter 307 may be (or may include) computer firmware, hardware, and/or software configured to modulate a carrier wave over a powerline 201 to which the intercom adapter 307 is removably or fixedly coupled. Audio data, image data, and/or control data may be included in the carrier wave that is received or modulated by the intercom adapter 307. Audio data in a carrier wave may include live sounds detected by an intercom speaker 304. Referring to FIGS. 2 and 3, image data included in a carrier wave may include live still and/or video images taken by an intercom camera 310 and/or by a camera 206 that is coupled with the powerline 201.

Control data in a carrier wave may include operational commands that are uniquely addressed to one or more components of the system 200. By way of example, control data may include a computer readable instruction to display a video image taken by a camera 206 on the intercom display 302. Alternatively, the control data may include a computer readable instruction that when executed activates an intercom microphone 312 and/or intercom camera 310 of another intercom station to allow remote monitoring of the image(s) and/or sound(s) that are detected (in real time or in near real time) at the location where the “another intercom station” is located.

Alternatively, the control data may include a computer readable instruction that when executed controls the operation of a household appliance or one or more pieces of household equipment (thermostat, lighting, entertainment system, security systems, and the like) that are coupled with the powerline 201. Alternatively, the control data may include a computer readable instruction that when executed distributes pre-recorded audio files to one or more intercom speakers 304 and/or speakers 213. Alternatively, the control data may include a computer readable instruction that when executed distributes pre-recorded video files to one or more display devices 207 and/or intercom display devices 302.

Methods of installing and operating the system 200 and intercom station(s) 205) are now described with respect to FIGS. 2 and 3. Unless otherwise expressly indicated to the contrary, the steps of the methods shown in FIGS. 2 and 3 may be performed in any suitable order. One or more steps of the method shown in FIG. 2 may be combined and/or interchanged with one or more steps of the method shown in FIG. 3, and vice versa.

A security system adapter 215 may be provided individually or in combination with one or more components of the system 200. The security system adapter 215 may be installed by coupling the security system adapter 215 to the master panel of the security system 214, and then plugging a cord (or male plug) coupled with the security system adapter 215 into a socket of an electrical outlet 202.

A powerline pluggable intercom station 205 may be provided individually or in combination with one or more other components of the system 200, and may be installed by plugging a cord (or male plug) coupled with the intercom adapter 307 into a socket of an electrical outlet 202. In an embodiment, the powerline-pluggable intercom station 205 may be pre-configured during manufacture, or manually configured during installation, to function as a security system interface for the security system 214.

Preferably, at least two powerline-pluggable intercom stations 205 are provided and coupled with the powerline 201. Provided that both intercom stations 205 are identically (or substantially similarly) configured, either may interchangeably serve as a central (master) intercom station or a remote (slave) intercom station. When operated as a central intercom station, the intercom station 205 may issue system control signals over the powerline to one or more other components of the system 200. When operated as a security system interface, the intercom station 205 may issue system control signals over the powerline 201 to one or more components of the security system 214, and/or may execute a system control signal, an audio signal, and an image signal received over the powerline 201 from the security system 214. When operated as a remote intercom station, the intercom station 205 may execute a system control signal received over the powerline from another (central) intercom station 205, from a handheld control device, and/or from a personal computer.

A computer processor 306 in the intercom station 205 may process the received computer-readable system control signal and execute it to adjust a sensitivity of an intercom microphone 312 and/or to transmit over the powerline, as part of a modulated carrier wave, a sound detected by the intercom microphone 312.

Optionally, the computer processor 306 may execute the processed system control signal to adjust a volume of the intercom speaker, to activate an intercom camera, and/or to transmit over the powerline 201, as part of a modulated carrier wave, an image captured by the intercom camera 310.

Optionally, the computer processor 306 may execute the processed system control signal to display a selected image file on an intercom display device 302 and/or to play a selected audio file over an intercom speaker 304.

Optionally, the computer processor 306 may execute the processed system control signal to record, in one of a memory device coupled with the powerline and an intercom memory device 305, the sound detected by the intercom microphone 312.

Optionally, the computer processor 306 may execute the processed system control signal to record, in one of a memory device coupled with the powerline 201 and an intercom memory device, an image captured by the intercom camera 310 and/or an image captured by a camera 206 coupled with the powerline 201.

In further operation, a powerline-pluggable intercom station 205 coupled with a powerline 201 may transmit over the powerline 201 a computer-readable system control signal. The transmitted computer-readable system control signal may be configured to cause adjustment of a volume of an audio output device 213 coupled with the powerline 201, to cause adjustment of a volume of a display device 207 coupled with the powerline 201, and/or to arm/disarm a security system 214 coupled with the powerline 201.

Optionally, the transmitted computer-readable system control signal may be further configured to select an audio file for distribution to at least one of an intercom speaker 304 and the audio output device 213; and/or configured to select an image file for distribution to at least one of an intercom display device 302 and a display device 207 coupled with the powerline 201.

The components and arrangements of embodiments of the claimed invention shown and described herein are illustrative only. Although only a few embodiments are described in detail, those skilled in the art who review this disclosure will readily appreciate that substitutions, modifications, changes and omissions may be made in the design, operating conditions and arrangement of these embodiments without departing from the scope of the appended claims, which is intended to include all such substitutions, modifications, changes, and omissions.

What is claimed is:

1. A system, comprising:
two intercom stations each configured to be coupled with a powerline, wherein at least one of the two intercom stations is configured to be mounted to a wall, and
wherein at least one of the two intercom stations includes an intercom adapter configured to transmit and receive a uniquely addressed, modulated carrier wave over the powerline.

2. The system of claim 1, further comprising:
a security system adapter configured to be coupled with a security system and with the powerline,
wherein the at least one of the two intercom stations is configured to function as a security interface for the security system.

3. The system of claim 1, wherein each of the two intercom stations further includes:
a computer processor coupled with the intercom adapter;
a memory coupled with at least the computer processor;
an intercom user interface coupled with the computer processor,
an intercom microphone coupled at least with the computer processor and configured to transmit over the powerline as part of the modulated carrier wave a sound detected by the intercom microphone;
an intercom speaker coupled with the computer processor; and
an intercom display device coupled at least with the computer processor.

4. The system of claim 3, further comprising:
a camera configured to be coupled with the powerline,
wherein the intercom display device is further configured to display at least one of system status and an image produced by the camera.

5. The system of claim 1, wherein at least one of the two intercom stations further comprises:
an intercom memory port coupled with at least the computer processor and configured to couple with an external memory device.

6. The system of claim 3, further comprising at least one of:
a display device configured to be coupled with the powerline; and
an audio output device configured to be coupled with the powerline.

7. The system of claim 6, further comprising:
an ethernet bridge configured to be coupled with the powerline, wherein the ethernet bridge is further configured to link at least one of the intercom stations, the audio output device, and the display device with a network.

8. The system of claim 1, wherein at least one of the two intercom stations further comprises:
an intercom sensor configured to detect system control signals transmitted via radio frequency or infrared frequency from a handheld control device.

9. A wall-mountable intercom station configured to couple with a powerline, the wall-mountable intercom station comprising:
an intercom adapter configured to transmit and receive a uniquely addressed, modulated carrier wave over the powerline.

10. The wall-mountable intercom station of claim 9, further comprising:
a computer processor coupled with the intercom adapter;
an intercom memory coupled with at least the computer processor;
a keypad coupled with the computer processor,
a microphone coupled at least with the computer processor and configured to transmit over the powerline as part of the modulated carrier wave a sound detected by the intercom microphone;
an intercom speaker coupled with the computer processor; and
an intercom display device coupled at least with the computer processor.

11. The wall-mountable intercom station of claim 10, wherein the
wherein the intercom display device is further configured to display at least one of system status and an image produced by a camera coupled with the powerline.

12. The wall-mountable intercom station of claim 11, further comprising:
an intercom memory port coupled with the intercom memory and configured to couple with a memory device.

13. The wall-mountable intercom station of claim 12, wherein the intercom display device is further configured to display at least one of visual command prompts, distributed audio/video zones, distributed video zones, an entertainment list, and an internet webpage.

14. The wall-mountable intercom station of claim 9, further comprising:
an intercom camera coupled at least with the computer processor,
a display device coupled with the powerline, wherein the display device is configured to display an image produced by the intercom camera.

15. A method for operating an intercom and distributed audio/video system with a security interface, the method comprising:
receiving at an intercom station coupled with a powerline a computer-readable system control signal from one of an intercom keypad, an intercom display device, a security system, and a user device;
processing the received computer-readable system control signal; and
executing the processed system control signal to perform at least one of the following actions:
adjusting a sensitivity of an intercom microphone; and
transmitting over the powerline, as part of a modulated carrier wave, a sound detected by the intercom microphone.

16. The method of claim 15, further comprising executing the processed system control signal to perform at least one of the following actions:
adjusting a volume of an intercom speaker;
activating an intercom camera; and
transmitting over the powerline, as part of a modulated carrier wave, an image captured by the intercom camera.

17. The method of claim 15, further comprising executing the processed system control signal to perform at least one of the following actions:
displaying a selected image file on an intercom display device; and
playing a selected audio file over an intercom speaker.

18. The method of claim 15, further comprising executing the processed system control signal to perform at least one of the following actions:
recording, in one of a memory device coupled with the powerline and an intercom memory device, the sound detected by the intercom microphone.

19. The method of claim 15, further comprising executing the processed system control signal to perform at least one of the following actions:
recording, in one of a memory device coupled with the powerline and an intercom memory device, at least one of an image captured by the intercom camera and an image captured by a camera coupled with the powerline.

20. A method, comprising:
transmitting from an intercom station coupled with a powerline, a computer-readable system control signal, the computer-readable system control signal configured to at least one of:
adjust a volume of an audio output device coupled with the powerline;
control a component of a security system, wherein the security system is coupled with the powerline via a security system adapter; and
adjust a volume of a display device coupled with the powerline.

21. The method of claim 20, wherein the computer-readable system control signal is further configured to at least one of:
select an audio file for distribution to at least one of an intercom speaker and the audio output device; and
select an image file for distribution to at least one of an intercom display device and a display device coupled with the powerline.
